(19) United States
(12) Patent Application Publication
(10) Pub. No.: US 2002/0194609 A1
(43) Pub. Date: Dec. 19, 2002

(54) Video client with dynamically allocable video buffer for efficiently streaming video

(76) Inventor: Thanh T. Tran, Houston, TX (US)

Correspondence Address: CONLEY ROSE & TAYON, P.C., P. O. BOX 3267, HOUSTON, TX, 77253-3267, US

(21) Appl. No.: 09/883,766

(22) Filed: Jun. 18, 2001

(51) Int. Cl. H04N 7/173

(52) U.S. Cl. 725/95; 725/91; 725/92; 725/114

(57) ABSTRACT

A video streaming network having a server and a client and the client includes a buffer that can be dynamically changed in response to changing communication channel conditions. The client initially allocates a portion of its system memory to be a video buffer based on a test procedure. During transmission of a video work from the server to the client, the server sends a plurality of video packets to fill the client's buffer. The client then retrieves the video data from its buffer and plays the video content on the display. The server, at appropriate times in a coordinated fashion, sends more video packets to top off the video buffer so that the buffer does not run dry. If the amount of data to be played fails to comport with a given set of criteria indicative of communication problems, the client increases the size of its buffer. The size of the buffer also can be dynamically reduced.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention generally relates to streaming information (e.g., video and audio) from a server to a client. The invention further relates to streaming information in an environment in which the information stream may encounter interference from other signal generating equipment. More particularly, the invention relates to a client buffering mechanism in which the buffer size can be dynamically varied to provide optimal storage capacity in the client given the amount of interference present in the communication channel between the server and client.

2. Background of the Invention

Computer technology has become capable of storing, processing, and displaying multimedia information. The term “multimedia” generally refers to audio and video information. For example, computers are available with DVD drives to permit users to watch a full-length movie. Multimedia content is available to consumers through a variety of sources including conventional television broadcasting, videocassettes, DVDs, etc. This content can be digitized (if not already in digital form) and further disseminated through the use of computer networks such as Local Area Networks (LANs), intranets, and the Internet. Multimedia content can be transmitted in a computer network over electrical or fiber optic cables or wirelessly. Several types of wireless networking systems are available to wirelessly transmit data including video and audio data. Such networks include communication protocols like Home RF, Bluetooth, IEEE 802.11, and others.

Generally, there are two ways to watch a video at one location on a network when the video is stored at a remote location. For purposes of this disclosure, the location which originates the video (be it a file or a live feed) is called a “server” and the location to which the video is transmitted for viewing is called a “client.” One way to watch a video at a client is to download the video in its entirety from the server, across the network to a storage facility (e.g., hard drive) on the client. Although this technique may be satisfactory for some situations, it is undesirable for others for various reasons. First, a 1½ hour DVD quality video may comprise from 3 to 10 gigabytes of compressed data. Downloading such a huge amount of data (even over a high-speed network connection) prior to viewing any part of the video, may take nearly as much time as it takes to view the entire video. Further, the client system would need at least 3 gigabytes of excess capacity in which to store the video. Although disk drives are available to accommodate such storage requirements, nonetheless, storage capacity may often be a problem.

An alternative approach to brute-force downloading the multimedia work before playing is “streaming.” Streaming allows a user on a client machine to watch and hear content as it is being downloaded from the server instead of having to wait for a full multimedia file to download before any of the content can be viewed or heard. There are several techniques available for streaming video. U.S. Pat. No. 5,963,202, incorporated herein by reference, describes one such streaming technique.

One problem with streaming multimedia is experienced when the communication channel from the server to client is “narrowed” or when there is heavy bus “traffic.” A communication channel has a maximum data transfer rate referred to as its maximum bandwidth. External, undesirable signals may interfere with the communication channel. When this happens, the channel may have to transfer data at a slower rate to avoid transmission errors. This is called “narrowing” the channel bandwidth. In other cases, multiple clients may need simultaneous access to the communication channel or bus to communicate with a common server. When multiple clients want to share the communication channel, bus traffic becomes heavy which reduces the time any one client can use the channel to access a server. If a server is unable to stream video content with sufficient speed relative to the rate at which the video is shown, the result is pauses in the video, garbled audio, and in some case complete cessation of the video. U.S. Pat. No. 5,963,202 explains that memory buffers can be used in the client to alleviate some of these problems by allowing the server to send extra information, while the channel is open, that is stored in the client's buffer for playback when the communication channel is unavailable.

One problem with such a buffering technique is that the buffer's size is fixed. If a buffer is set too small to accommodate a long period of channel unavailability, the video may need to pause while the client waits for more data from the server to fill the buffer. If, however, the buffer size is increased to a size beyond what is needed to prevent video stoppage, valuable memory resources are prevented from being used by other functions that the client machine may be trying to perform. Further, even if the buffer is allocated based on the environment at the beginning of the multimedia transmission, changes in the quality of the communication channel may result in the buffer size no longer being suitable. For example, IEEE 802.11 wireless networks and microwave ovens operate in the same frequency spectrum as many common cordless telephones. While in use, signals from the cordless telephone may interfere with the data transmissions across the IEEE 802.11 network forcing the IEEE 802.11 network to cease data transfers until the interference from the phone ceases. This may be an acceptable condition when transferring normal data (e.g., text) on the IEEE 802.11 network, but it is not acceptable for use with streaming video because of the video content's time sensitive nature. If the client's buffer size is preset to accommodate situations when the cordless phone is in use, the buffer will be unnecessarily large for times when the cordless phone is not in use. Likewise, if the buffer is allocated when the cordless phone is not in use, use of the cordless phone may result in undesirable effects (e.g., pausing) associated with the streaming video. A solution to this problem is needed.

### BRIEF SUMMARY OF THE INVENTION

The problems noted above are solved in large part by a video server-client system in which the client includes a buffer that can be dynamically changed (i.e., on the fly) in response to changing communication channel conditions. The system includes at least one video client and at least one video server. The video client includes a processor, system memory, a display, and a networking unit to communicate with the server. The client preferably has a wireless link to the server. The client first allocates a portion of its system memory to be a video buffer. The amount of memory that is allocated for the video buffer is determined based on the round trip time a test packet takes to travel from the client to the server and back to the client. That round trip time may be influenced by external factors such as electromagnetic interference.

During transmission of a video work from the server to the client, the server sends a plurality of video packets to fill the client's buffer. The client then retrieves the video data from its buffer and plays the video content on the display. The server, at appropriate times in a coordinated fashion, sends more video packets to top off the video buffer so that the buffer does not run dry.

If, however, the amount of data to be played (the unplayed video data) in the buffer fails to comport with a given set of predetermined or programmable criteria which are indicative of a problem with video packets being able to be accurately received by the client, the client automatically (i.e., preferably without human intervention) increases the size of its buffer to reduce the risk that future communication problems will cause the client's video buffer to run dry. Once the client increases its buffer, the server fills the buffer at a rate that exceeds the encoded play rate of the video data. The size of the buffer also can be dynamically reduced, for example, in the absence of interference and/or unexpected latency problems.

These and other advantages will become apparent upon reviewing the following description and drawings.

### BRIEF DESCRIPTION OF THE DRAWINGS

For a detailed description of the preferred embodiments of the invention, reference will now be made to the accompanying drawings in which:

FIG. 1 is a block diagram of a preferred embodiment of a video server-client system;

FIG. 2 is a block diagram of a video client shown FIG. 1;

FIG. 3 is a block diagram of a video server shown FIG. 1; and

FIGS. 4A-4D illustrate the allocation of additional memory for a video buffer in a client if extraneous interference so warrants; and

FIGS. 5A and 5B illustrate a de-allocation of memory when a smaller video buffer is acceptable.

### NOTATION AND NOMENCLATURE

Certain terms are used throughout the following description and claims to refer to particular system components. As one skilled in the art will appreciate, different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

As explained below, a video client includes a “dynamically” adjustable video buffer. The word “dynamically” means that and aspect of the buffer (e.g., its capacity) can be changed during initialization as well as after initialization and during the reception of a video stream. Dynamically changing the buffer may also be referred to as changing the buffer “on the fly.”

The term “streaming” means the process of transmitting a multimedia work from one device to another in which the recipient device can begin playing the work before the entire work is completed being received by the recipient device.

### DETAILED DESCRIPTION OF THE PREFERRED EMBODIMENTS

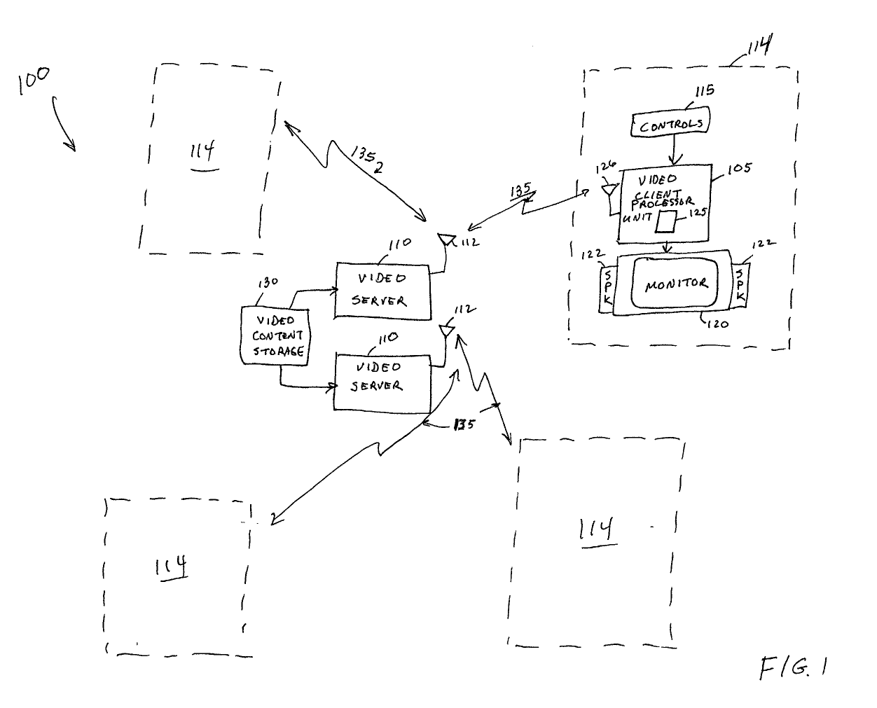

FIG. 1 is a block diagram of a multimedia content network 100 constructed in accordance with a preferred embodiment of the invention. As shown, the network 100 comprises one or more video servers 110 which communicate with one or more video clients 114 through a communication channel 135. A multimedia content storage device 130 couples to the video servers 110 as shown, or each server 110 may have its own dedicated content storage 130. Video clients 114 include a video client processor unit 105, user controls 115, a monitor 120 and one or more speakers 122. The client processor unit 105 includes a video buffer 125 whose use will be described in detail below. In general, however, the buffer 125 has a storage capacity which processor unit 105 can dynamically change to efficiently receive and play video on monitor 120 and audio on speakers 122 in the face of changing environmental conditions (e.g., electromagnetic interference).

In the preferred embodiment, the servers 110 and clients 114 may be implemented as standard computer systems such as those currently available which support display and data handling of video. Multimedia content network 100 may also comprise a network of “set-top” boxes whose general construction and use is well known to those of ordinary skill in the art. In the context of a set top box, monitor 120 and speakers 122 comprise a television set. In a home application, multimedia set top boxes may each be connected to a television. The set top box allows a user to perform conventional computer functions such as “surfing” the Internet, using word processing applications, playing video games, as well as watching television and other functions as might be imagined using a computer/television hybrid system. The server set top box 110 differs from the client set-top box in that the server 110 couples to multimedia content storage hardware 130 such as a DVD drive, whereas clients 114 may or may not have a DVD drive. Further, the server may not have a monitor, but can if desired. In general, if a user wishes to view a video on a monitor 120 coupled to a client 114, the video, which is stored at the server location on content storage device 130, is streamed from the server 110 to client 114.

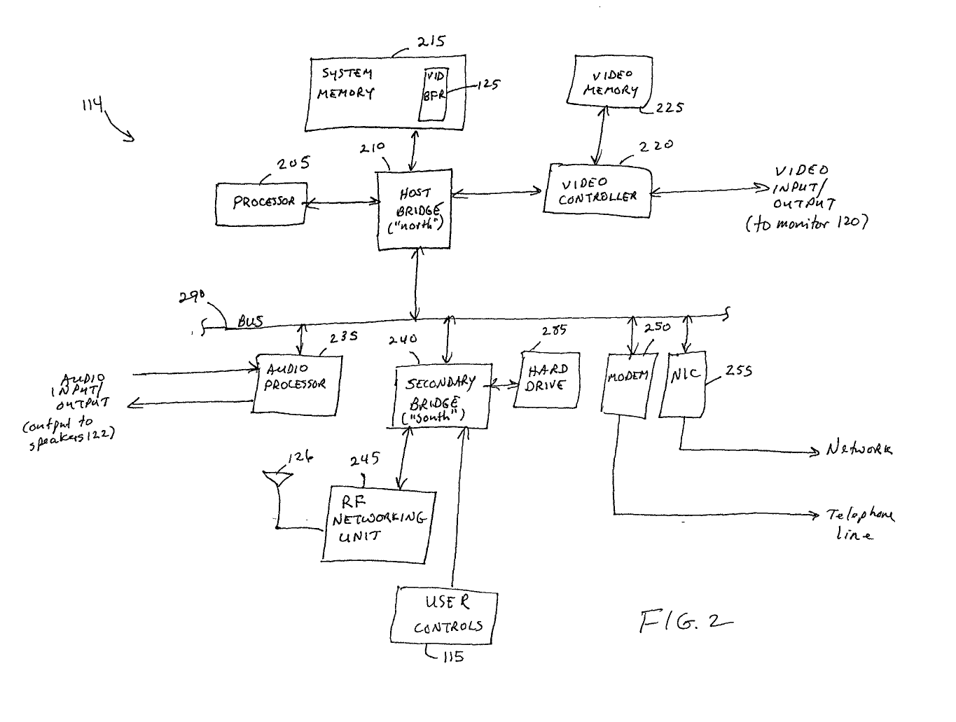

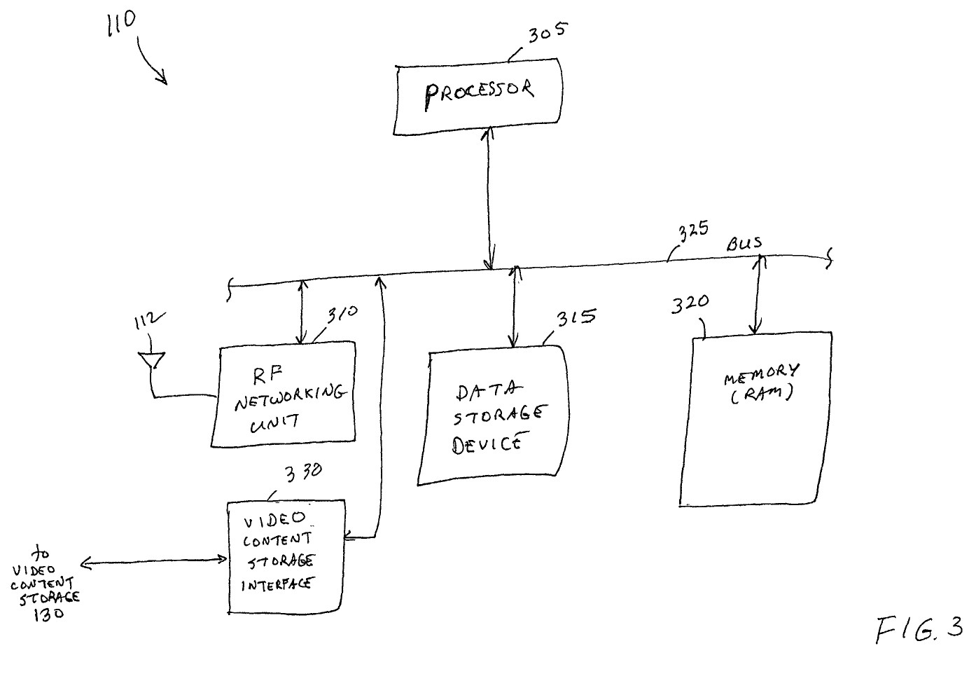

The communication channel 135 preferably is implemented as a wireless connection using antennas 112 and 126. The bandwidth of such a wireless communication channel preferably is sufficiently large to accommodate a video quality bit-stream. Other types of communication channels 135, such as using physical cables (e.g., Ethernet), may also be used. The video client 114 and video server 110 communicate with each other using the communication channel 135 through networking hardware (shown in FIGS. 2 and 3) integral to the video client 114 and video server 110 systems. Although communication channels permitting DVD quality (or similar) video transmission is preferable, alternatively, networks with lower bandwidths may be used in embodiments requiring less than DVD quality video.

Multimedia content storage device 130 in the preferred embodiment may be a hard drive that stores a digitally encoded video, which may be compressed with the MPEG-2 compression technique. Additionally, multimedia content storage device 130 can include digital television receivers, writable DVDs, analog-to-digital encoders or other suitable hardware either integral to or separate from the video server 110. The multimedia storage 130 preferably is capable of storing video chips in any now known or later developed format such as MPEG or AVI.

User controls 115 in the preferred embodiment include hardware keys connected to the video client processor unit. The hardware keys may be similar to those on DVD and VCR devices and include such functions as “play,” “stop,” “pause,” “fast-forward,” “rewind,” etc. User controls 115 may also comprise a mouse or keyboard, such as those commonly used in modern computer systems which allows the user to make video selections using “point and click” or “hot-key” commands. Further, user controls 115 may wirelessly couple to video client processor unit 105.

The video monitor 120 may comprise a cathode ray tube (“CRT”) style monitor or a liquid crystal display (“LCD”) flat-panel monitor or any other type of monitor capable of displaying the signals generated by the video client 114. The video monitor 120 may be capable of receiving digital or analog signals. As noted above, monitor 120 may comprise a standard television set that is connected to a set top box.

FIG. 2 shows a more detailed block diagram of video client 114. Referring to FIG. 2, the video client 114 preferably comprises a processor 205, a host (or “north”) bridge 210, system memory 215, a video controller 220, video memory 225, an audio processor 235, a secondary (or “south”) bridge 240, a radio frequency networking unit 245, a modem 250, a network interface (NIC) 255, user controls 115, and a hard-drive 285. The host bridge 210 couples to the processor 205, system memory 215, video controller 220 and various other components as shown via bus 290. The host bridge 210 preferably includes a memory controller (not specifically shown) to permit efficient use of system memory 215 by the processor 205 and various other devices in the client 114. The video memory 225 couples to the video controller 220. The monitor 120 preferably receives video signals from the video controller 220. The processor 205 coordinates the transfer of video data from system 215 to video memory 225. Video controller 220 reads the video data from video memory 225 and formats the data in a suitable format and transmits the video signals to monitor 120.

The audio processor 235, secondary bridge 240, modem 250 and NIC 255 also couple to the bus 290, which in the preferred embodiment is a peripheral component interconnect (PCI) bus, but may be any other suitable bus architecture. The secondary bridge 240 also couples to the hard drive 285 and to the RF networking unit 245 and receives input control signals from a user via the user controls 115. In general, the secondary bridge 240 receives input control signals from user controls 115 and the processor 205 reads registers internal to the secondary bridge 240 to determine what function the user has selected. The processor 205 then responds appropriately. An example of such a response might be to send a request to a server 110 to begin streaming video the client 114. The hard drive 285 preferably contains software executed by processor 205 such as software that implements the functionality described herein. The secondary bridge 240 may also include interfaces for a universal serial bus (USB), parallel and serial port inputs, keyboard and mouse inputs, CD-ROM, DVD, and floppy disk drives. Information can be read from or written to hard drive 285 via the secondary bridge 240. The audio processor 235 may be connected to speakers 122 to drive the speakers. The modem 250 may be used to connect to a telephone line and/or the NIC 255 may be used to connect to a network. The RF networking unit 245, in conjunction with antenna 126, are used to wirelessly communicate with the server 110.

Any well-known or later developed components can be used to implement the components shown in FIG. 2. For example, processor 205 in the preferred embodiment may be any suitable processor capable of processing DVD quality video data in real time such as those produced by Intel, AMD, and Motorola or any other that may be produced by these or other manufacturers. If high quality video (e.g., DVD quality) is not important, lesser capable processors can be used if desired. The host bridge 210 may be of the type provided by Intel or VIA. The system memory 215 may be any suitable type of memory such as random access memory (“RAM”) and the various variations on RAM such as dynamic random access memory (“DRAM”), synchronous DRAM (“SDRAM”) and the like. The video controller may be the Trident Blade 3D video engine.

FIG. 3 represents an exemplary embodiment of a video content server 110. As shown, server 110 comprises a processor 305, a RF network unit 310, a data storage device 315, system memory 320, and a video content storage interface 330. These components are all coupled together via a bus 325 which may comprise a PCI or other suitable bus. The processor 305 in the preferred embodiment can be of the type currently produced by Intel, AMD, or Motorola. The data storage device 315 preferably comprises a hard drive such as those currently known in the art. The data storage device 315 contains software executed by processor 305 such as software for streaming multimedia data.

Referring again to FIG. 2, in accordance with the preferred embodiment of the invention, a portion (or all if desired) of the client's system memory 215 can be allocated as the video buffer 125. The video buffer 125 is used by the client 114 to store incoming packets of video data from the server 110. Although the term “video” packet or “video” data is used, it should be understood that, broadly, video only, audio only, or a combination of video and audio comprise the packets/data. Any suitable method for transmitting the video work from the server 110 to a client 114 is acceptable. U.S. Pat. No. 5,963,202, incorporated herein by reference, describes one suitable technique of streaming video from a server to a client. As an overview, U.S. Pat. No. 5,963,202 discloses a client video buffer being loaded by a server at a rate faster than the encoded play rate of the video data. The client then plays the video from its video buffer and can begin playing the video without the entire video work being fully downloaded to the client first. At appropriate times, such as at predetermined time intervals or when the video buffer only has a predetermined threshold amount of data yet to be played, the server transmits additional packets of video data to refill the client's buffer at a rate that exceeds the encoded play rate of the video data (i.e., Faster Than Real Time®). Such a streaming technique, or other techniques, can be used to transmit packets of video data from the server 110 to the client 114 to be stored in the client's video buffer 125. The video packets preferably are transmitted from server to client using the wireless communication link 135 described above.

As noted above, the wireless communication link 135 may experience periodic episodes of electromagnetic interference from sources external to multimedia content network 100. Such interference may prevent the clients 114 from accurately receiving one or more packets of video data from a server 110. Clients 114 preferably include error detection and correction logic, which is well known to those of ordinary skill in the art, and may be implemented in hardware or software. If the client 114 detects, but cannot correct, a transmission error which may have occurred due to external interference, the client requests the server to resend the packet. When the server resends the packet, there may still be enough interference to cause the packet again not to be accurately received by the client. This may occur for a number of sequential packets. During an episode of interference preventing packets from being accurately received by the client, the client 114 is able to continue playing the video to the user as it retrieves packets already correctly sent to by the server and stored in the client video buffer 125. That is, the video data stored in the client's video buffer 125 permits the client to tolerate some disruption in communication with the server. If, however, the episode of interference persists long enough, the video buffer 125 may be depleted or nearly depleted before the server 110 is able to once again fill it.

In accordance with the preferred embodiment of the invention, the client 114 monitors the communication between server and client to detect, determine or infer the presence of the aforementioned periods of inability of the client 114 to accurately receive video packets from the server. The process for how the client makes this determination will be described below. In general, the client can directly detect the presence of external electromagnetic interference or indirectly infer its presence by monitoring the status of the video buffer. The preferred embodiment described below performs the latter. Once the client 114 determines the presence of this condition, the client's processor 205 requests a larger allocation of memory 215 for the video buffer. That is, the capacity of the video buffer 125 is enlarged. With a larger video buffer 125 and once the client is again able to accurately receive video packets, the client fills the video buffer 125 at a rate that exceeds the encoded play rate of the video data, such as is described in U.S. Pat. No. 5,963,202. With more video data now in buffer 125, the likelihood is decreased that the buffer will exhaust all of its data in the face of future communication interference.

In accordance with the preferred embodiment of the invention, the client's processor 205 checks whether a condition is true that is indicative of the video buffer 125 becoming almost depleted, which in turn suggests that the client 114 is unable to accurately receive video packets from server 110. There are various conditions that can monitored. For example, client 114 (and preferably the processor 205) may monitor the amount of data yet to be played in the buffer 125 to determine if that amount falls below a predetermined or programmed threshold. The client may continuously calculate the percentage of the total buffer capacity that contains data yet to be played. Instead of a percentage, the client may simply monitor how much data (e.g., in bytes) the buffer contains to be played. If that amount falls below the threshold, the client 114 determines that the video buffer 125 needs to made larger. By way of example, if the amount of data yet to be played from the buffer 125 falls below 10% of the total buffer capacity (or below 1 MB in a 10 MB buffer), the client enlarges the buffer 125.

Alternatively, the client may monitor the status of the video buffer 125 to determine if the amount of data yet to be played in the buffer falls below a threshold more than a certain number of times in a certain amount of time. Accordingly, if the amount of data yet to be played in the buffer falls below a threshold (A) more than (B) times in (C) seconds, then the client 114 allocates more memory 215 for the video buffer 125. By way of an example, A could be 10%, B 4, and C 30 seconds. As such, if four times in 30 seconds less than 10% of the client's video buffer contains data to be played (i.e., 90% of the buffer's data has already been played and is thus “old” data), the client allocates more memory to increase the size of the client buffer.

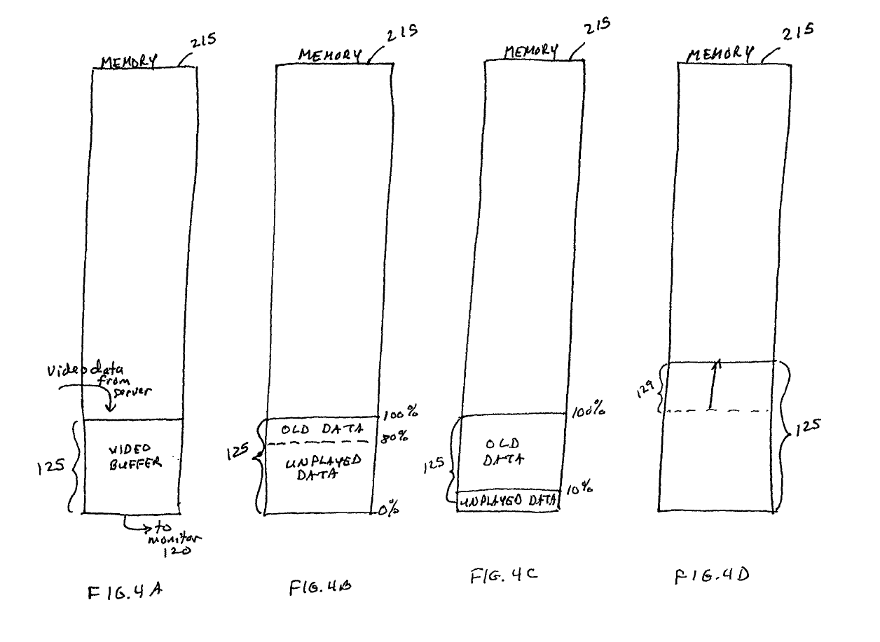

This process is illustrated with reference to FIGS. 4A-4D. In FIG. 4A, a portion of the client's memory 215 has been allocated to comprise the video buffer 125. FIG. 4A also illustrates conceptually that video data provided from the server to the client's video buffer 125 is read from the buffer by the client and played on monitor 120 and speakers 122 and that the server 110 refills the buffer at appropriate times. In FIG. 4B, 15% of the buffer has been played and is thus old data, while 85% of the buffer's total capacity still has new video data that has not yet been played on monitor 120. In FIG. 4C, 90% of the buffer has been played and only 10% of the buffer has unplayed data. As explained above, the client's processor 205 may simply monitor the buffer 125 to determine when the amount of unplayed data drops below a threshold. Assuming the threshold (A) is set at 10%, the condition illustrated in FIG. 4C would cause the client 114 to allocate more memory 215 for the buffer, which is illustrated in FIG. 4D where the client video buffer 125 is shown to be larger by an extra memory allocation 129. The client 114 might also determine whether the condition in FIG. 4C has occurred more than 4 times (in general, B times) in 30 seconds (in general, C times) and only then cause more memory 215 to be allocated to make the buffer larger.

The amount of the additional memory allocated for use by the video buffer 125 may be predetermined, programmed or calculated in some suitable manner such as a percentage of the buffer size. For example, the allocated amount of memory may be 10% of the buffer size. Further, if desired, the client's de-allocation procedure can be configured to ensure that the capacity of the video buffer 125 never exceeds a predetermined or programmable threshold. As such, the client may ensure that the amount of memory 215 allocated for the video buffer is never greater than some acceptable maximum level (e.g., 64 MB). In this way, enough of the memory 215 is left for use by other client processes to ensure satisfactory operation of the client 114.

Because the client's memory 215 is a common resource used by numerous client processes, it is generally desirable to allocate no more of the client's memory 215 than is necessary to effectively implement the video buffer. The memory allocated for the video buffer 125 is memory that is unavailable for other client functions. The client 114, therefore, preferably de-allocates memory from the video buffer 125 when the client determines that the buffer need not be as larger as it is.

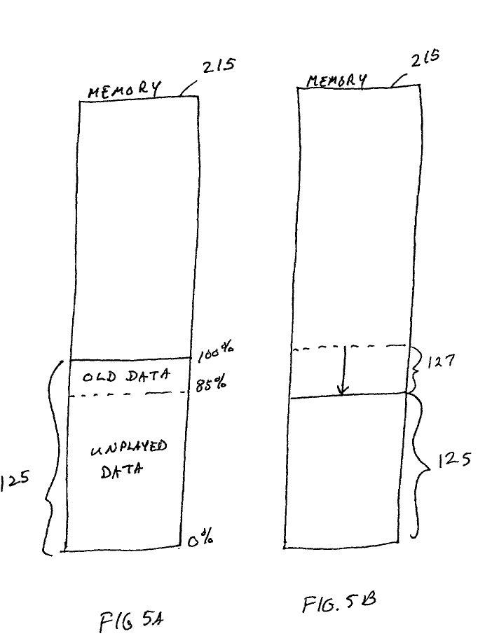

Any of a variety of techniques can be implemented by the client 114 to determine when to de-allocate a portion of video buffer 125. For example, the client's processor 205 can monitor the status of the video buffer 125 to determine whether the amount of unplayed data contained in the buffer ever falls below a predetermined or programmable threshold over a certain time period. FIGS. 5A and 5B illustrate this technique. If the client's processor 205 determines that the amount of unplayed data in the video buffer does not drop below, for example, 85% (or a certain number of bytes) of the total buffer capacity over a 30 second period of time, then the processor 205 determines that the buffer is larger than necessary and de-allocates a portion 127 of the buffer. The de-allocated memory portion 127 is then freed up to be used by other processes in the client 114 as desired.

The amount of the de-allocation may be predetermined, programmed or calculated in some suitable manner such as a percentage of the buffer size. For example, the de-allocated amount of memory may be 10% of the buffer size. If desired, the client's de-allocation procedure can be configured to ensure the capacity of the video buffer 125 never falls below a predetermined or programmable threshold. As such, the client ensures that the amount of memory 215 allocated for the video buffer is always at least at some acceptable minimum level (e.g., 10 MB).

The above discussion is meant to be illustrative of the principles and various embodiments of the present invention. Numerous variations and modifications will become apparent to those skilled in the art once the above disclosure is fully appreciated. It should be understood that the preferred embodiment described above need not be limited to situations in which externally generated interference is present, but more broadly applies to any instance in which a multimedia stream is unable to keep the client's video buffer sufficiently full. It is intended that the following claims be interpreted to embrace all such variations and modifications.

What is claimed is:

1. A video distribution network, comprising:
a video server; and
a video client operatively coupled to said server and receives video packets from the server, said video client including a video buffer in which said video packets received from the server are stored and whose capacity can be dynamically adjusted.

2. The video distribution network of claim 1 wherein the capacity of said video buffer can be dynamically increased.

3. The video distribution network of claim 1 wherein the capacity of said video buffer can be dynamically decreased.

4. The video distribution system of claim 1 wherein said client includes memory and said video buffer comprises a portion of said memory.

5. The video distribution system of claim 4 wherein the capacity of said video buffer can be dynamically increased by allocating more of said memory for use by the video buffer.

6. The video distribution system of claim 4 wherein the capacity of said video buffer can be dynamically decreased by de-allocating a portion of said video buffer.

7. The video distribution system of claim 1 wherein said server and said client are operatively coupled together via a wireless transmission link.

8. The video distribution system of claim 1 wherein said client monitors the amount of unplayed video packets stored in said video buffer and based on the amount of unplayed video packets, increases the capacity of said video buffer.

9. The video distribution system of claim 8 wherein said client monitors the amount of unplayed video packets stored in said video buffer to determine if said the amount of unplayed video packets falls below a threshold A, B times in period of C seconds, where A indicates a portion of the capacity of the buffer, B is an integer greater than 0, and C is greater than 0.

10. The video distribution system of claim 8 wherein said client monitors the amount of unplayed video packets stored in said video buffer to determine if said the amount of unplayed video packets falls below a threshold A, where A indicates a portion of the capacity of the buffer.

11. The video distribution system of claim 1 wherein said client monitors the amount of unplayed video packets stored in said video buffer and based on the amount of unplayed video packets, decreases the capacity of said video buffer.

12. The video distribution system of claim 11 wherein said client monitors the amount of unplayed video packets stored in said video buffer to determine if the amount of unplayed video packets falls below a threshold D over E period of time, where D indicates a portion of the capacity of the buffer and E indicates a time period, and the amount of unplayed video packets does not fall below threshold D over E period of time, then the client reduces the capacity of said video buffer.

13. The video distribution system of claim 1 wherein said client transmits a test data packet to said server which returns the test data packet back to said client and said client determines the size of said video buffer based on the round trip time that the test data packet took to go from the client to the server and back to the client.

14. The video distribution system of claim 13 wherein, while receiving video packets from said server, said client transmits a test data packet to said server which returns the test data packet back to said client and said client adjusts the size of said video buffer based on the round trip time that the test data packet took to go from the client to the server and back to the client.

15. A client which received multimedia data, comprising:
a processor;
a system memory coupled to said processor; and
a communication unit coupled to said processor and said system memory, said communication unit receives the multimedia data;
wherein said processor allocates a portion of system memory as a buffer to receive the multimedia data, said buffer having a capacity that can be changed while the client receives the multimedia data.

16. The client of claim 15 wherein the capacity of said buffer can be dynamically increased.

17. The client of claim 15 wherein the capacity of said buffer can be dynamically decreased.

18. The client of claim 15 wherein said processor allocates a portion of said system memory before receiving multimedia data into said buffer.

19. The client of claim 15 wherein the capacity of said video buffer can be dynamically increased by allocating more of said memory for use by the buffer.

20. The client of claim 15 wherein the capacity of said video buffer can be dynamically decreased by de-allocating a portion of said buffer.

21. The client of claim 15 wherein said client receives said multimedia data via wireless communication.

22. The client of claim 15 wherein said client monitors the amount of unplayed multimedia data stored in said buffer and based on the amount of unplayed multimedia data, increases the capacity of said buffer.

23. The client of claim 22 wherein said processor monitors the amount of unplayed multimedia data stored in said buffer to determine if said the amount of unplayed multimedia data falls below a threshold A B times in period of C seconds, where A indicates a portion of the capacity of the buffer, B is an integer greater than 0, and C is greater than 0.

24. The client of claim 22 wherein said client monitors the amount of unplayed multimedia data stored in said buffer to determine if said the amount of unplayed multimedia data falls below a threshold A, where A indicates a portion of the capacity of the buffer.

25. The client of claim 15 wherein said client monitors the amount of unplayed multimedia data stored in said buffer and based on the amount of unplayed multimedia data, decreases the capacity of said buffer.

26. The client of claim 25 wherein said client monitors the amount of unplayed multimedia data stored in said buffer to determine if the amount of unplayed multimedia data falls below a threshold D over E period of time, where D indicates a portion of the capacity of the buffer and E indicates a time period, and the amount of unplayed multimedia data does not fall below threshold D over E period of time, then the client reduces the capacity of said buffer.

27. The client of claim 15 wherein said client receives said multimedia data from a server, and wherein said client transmits a test data packet to said server which returns the test data packet back to said client and said processor determines the size of said buffer based on the round trip time that the test data packet took to go from the client to the server and back to the client.

28. The client of claim 27 wherein, while receiving video packets from said server, said client transmits a test data packet to said server which returns the test data packet back to said client and said processor adjusts the size of said buffer based on the round trip time that the test data packet took to go from the client to the server and back to the client.

29. A method for streaming video from a server to a client across a network, comprising:
(a) sending a test packet across the network from the client to the server;
(b) receiving the test packet from the server back to the client;
(c) measuring the amount of time the test packet took to travel from the client to the server and back to the client;
(d) allocating a portion of memory to be a video buffer based on the time measure in (c);
(e) receiving video packets from the server; and
(f) storing said video packets in said video buffer.

30. The method of claim 29 further including retrieving said video packets from said video buffer and playing said packets on a monitor.

31. The method of claim 29 further including dynamically changing the size of said video buffer after said client has performed (d) and has begun receiving video packets from said server.

32. The method of claim 31 wherein dynamically changing the size of said video buffer includes allocating more memory to make the size larger.

33. The method of claim 31 wherein dynamically changing the size of said video buffer includes making the size of the video buffer smaller.
